(19) United States
(12) Patent Application Publication
(10) Pub. No.: US 2010/0248027 A1
(43) Pub. Date: Sep. 30, 2010

(54) BATTERY ELECTRODE SHEET, METHOD AND BATTERY WITH THE SAME

(76) Inventors: Tianci ZHANG, Shenzhen (CN); Juntao Xu, Shenzhen (CN); Xiaoyong Yan, Shenzhen (CN); Huajun Sun, Shenzhen (CN)

Correspondence Address: BRINKS HOFER GILSON & LIONE, P.O. BOX 10395, CHICAGO, IL, 60610, US

(21) Appl. No.: 12/749,229

(22) Filed: Mar. 29, 2010

(30) Foreign Application Priority Data
Mar. 31, 2009 (CN) 200910049001.4

(51) Int. Cl. H01M 4/02; B05D 5/12; H01M 4/04

(52) U.S. Cl. 429/209; 427/58

(57) ABSTRACT

A battery electrode sheet comprises a conductive substrate with two sides, and a first and second layer of an electrode material. The first and second layers of the electrode material are coated on at least one side of the conductive substrate. The first and second layers are deposited in separate steps.

### CROSS-REFERENCE TO RELATED APPLICATIONS

This application claims priority to Chinese Patent Application No. 200910049001.4, filed Mar. 31, 2009, the entire contents of which are incorporated herein by reference.

### TECHNICAL FIELD

The present disclosure relates to a battery electrode sheet, a method for preparing a battery electrode sheet, and a battery employing the same.

### BACKGROUND

The amount of the electrode active component on the electrode sheet is one of the important factors that affect the battery capacity. For example, in lithium ion secondary batteries, the amount of the active component, especially the positive active component, affects the capacity and the cycling performance of the battery. The conventional process of preparing the battery electrode sheet includes coating and pressing steps. A slurry of an electrode material is coated onto a conductive substrate to form a coating layer. Then the coated substrate is dried and pressed to form a battery electrode sheet. Typically, each of the coating, drying and pressing processes is only performed once. For a conductive substrate with a certain size, the battery capacity is generally increased by increasing the amount of the positive active component on the conductive substrate.

There are a few disadvantages in the above conventional process. First, the size of a battery shell may limit the thickness of the electrode sheet, thus limiting the amount of the electrode active component. The battery capacity may be difficult to improve by increasing the amount of the electron active component. Second, a large amount of the electrode active component may cause uneven surface of the coating layer. Third, the coating layer may be easy to peel away from the conductive substrate in one-layer coating. Therefore, the surface of the electrode sheet may not be smooth, thus affecting the cycling performance of the battery.

### SUMMARY

In one aspect, a battery electrode sheet comprises a conductive substrate with two sides, and a first and second layer of an electrode material. The first and second layers of the electrode material are coated on at least one side of the conductive substrate. The first and second layers are deposited in separate steps.

In another aspect, a method for preparing a battery electrode sheet comprises: providing a first slurry of an electrode material; coating the first slurry onto a conductive substrate to form a first layer of the electrode material; drying the first layer; pressing the first layer; providing a second slurry of an electrode material; coating the second slurry onto the first layer to form a second layer of the electrode material; drying the second layer; and pressing the second layer to form a battery electrode sheet.

In yet another aspect, a battery comprises a battery shell, an electrolyte disposed in the battery shell, and an electrode assembly disposed in the battery shell. The electrode assembly comprises a positive sheet, a negative sheet, and a separator disposed between the positive sheet and the negative sheet. At least one of the positive sheet and the negative sheet comprises a conductive substrate, and a first and second layer on the conductive substrate. The first and second layers are deposited in separate steps.

### BRIEF DESCRIPTION OF THE DRAWINGS

FIG. 1 is a sectional view of a battery electrode sheet, according to one embodiment of the present disclosure.

FIGS. 2A-2C show a first coating step, a first drying step and a first pressing step, according to one embodiment of the present disclosure.

FIGS. 2D-2F show a second coating step, a second drying step and a second pressing step, according to one embodiment of the present disclosure.

FIG. 3 shows a conductive substrate with a first and second layer of the electrode material on the both sides, according to one embodiment of the present disclosure.

### DETAILED DESCRIPTION OF THE EMBODIMENTS OF THE DISCLOSURE

The embodiments of the present disclosure will be described in detail with reference to the drawings as follows.

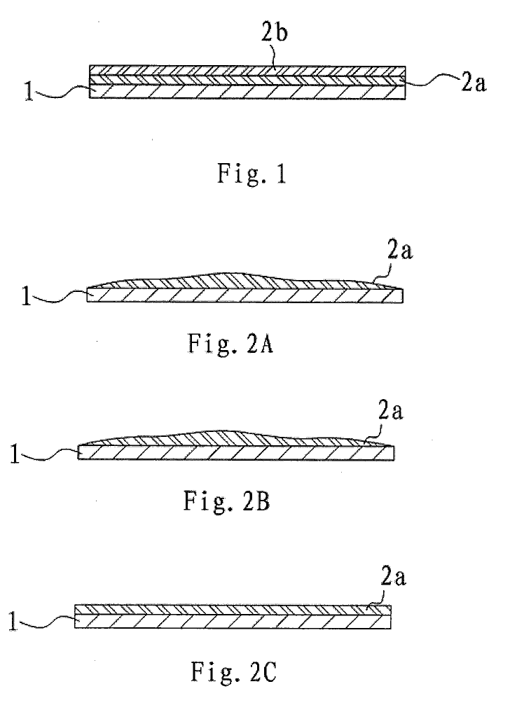

As shown in FIG. 1, according to one embodiment, the battery electrode sheet comprises a conductive substrate 1 and two layers of the electrode material, i.e. a first layer 2a and a second layer 2b. Both of the first and second layers comprise electrode active components. The first layer 2a is coated on the conductive substrate 1. The second layer 2b is coated on the first electrode material layer 2a. In some embodiments, the first layer 2a has a higher density than that of the second layer 2b. The electrode sheet can include two or more layers of the electrode material.

In addition, the first and second layers 2a and 2b are not limited to be coated on one side of the conductive substrate 1. As shown in FIG. 3, the first and second layers 2a and 2b are coated on both sides of the conductive substrate 1.

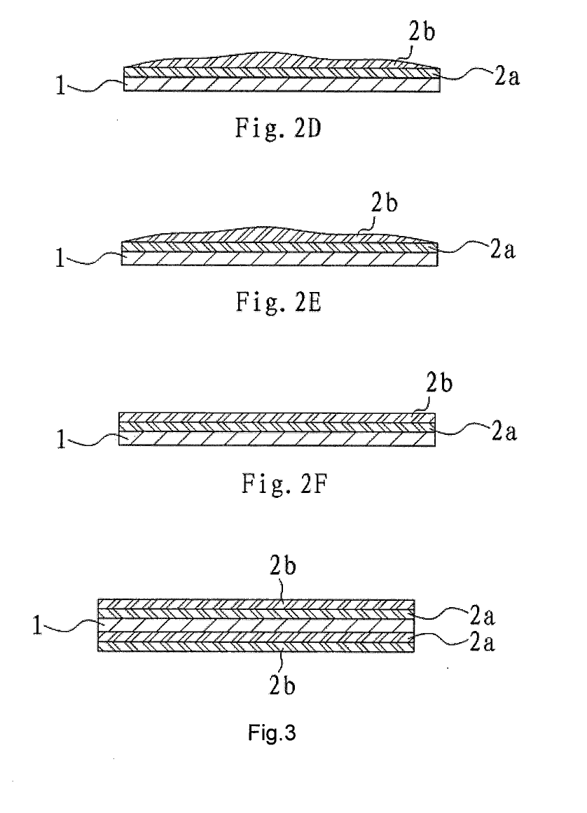

The method for preparing the above battery electrode sheet will be described in detail with reference to FIGS. 2A to 2F.

According to one embodiment, the method for preparing the above battery electrode sheet comprises: providing a first slurry of an electrode material, coating the slurry onto a conductive substrate to form a first layer, drying the first layer, pressing the first layer, providing a second slurry of the electrode material, coating the second slurry onto the first layer to form a second electrode layer, drying the second layer, pressing the second layer to form a battery electrode sheet. The method can further comprise coating a third layer of the electrode material onto the second layer.

The first and second slurrys can be any suitable materials. For example, the positive material of a lithium secondary battery generally comprises a positive active component and an adhesive agent. The negative material generally comprises a negative active component, an adhesive agent and optionally a conductive agent. In a nickel-metal hydride battery, the positive material typically comprises a positive active component and a binder.

As shown in FIG. 2A, the electrode material is coated onto the one side of the conductive substrate 1. Preferably, the electrode material is coated onto both sides of the battery electrode sheet 1, as shown in FIG. 3.

As shown in FIG. 2B, the conductive substrate 1 with the coated layer 2a is dried. Then, the conductive substrate 1 is pressed to provide a coating layer 2a with substantially even thickness, shown in FIG. 2C. As shown in FIG. 2D, the electrode material slurry is coated onto the first layer 2a to form a second electrode material layer 2b. The conductive substrate 1 is dried in FIG. 2E. As shown in FIG. 2F, the coated conductive substrate 1 is pressed to provided a second coating layer with substantially even thickness.

According to the one embodiment of the present disclosure, the coating, drying and pressing steps are performed on both sides of the conductive substrate. The conductive substrate 1 has two layers 2a and two layers 2b.

According to some embodiments, each of coating, drying and pressing steps are performed three times or more, so that three or more layers are formed on the conductive substrate 1.

Preferably, the first layer is pressed for more times than the second layer. For example, for the electrode sheet has two layers of the electrode material, the first layer 2a is pressed twice, and the second material layer 2b is pressed only once. For the electrode sheet has three layers, the first layer is pressed three times. The second material layer is pressed twice. The third material layer is pressed once. Therefore, the first layer 2a has a greater density than the second layer 2b, and the second layer 2b has a greater density than the third layer.

Preferably, the pressing forces applied onto the unit area of the electrode sheet in different pressing steps are similar. Therefore, the uniformity of the coating layers can be improved.

Preferably, the thickness of the electrode material coated in a former coating step is smaller than that of the electrode material coated in a later coating step. For example, the thickness of the second layer 2b is greater than that of the first layer 2a. More preferably, the difference of the thicknesses between the two adjacent electrode material layers is no larger than 50% of the thickness of the layer that has a larger thickness. For example, the difference of the thicknesses between the first layer and the second layer is no greater than about 50% of the thickness of the layer that has a greater thickness.

In one embodiment, preferably, the electrode material slurry has a viscosity of between about 2000 and about 4000 cP. More preferably, the viscosity is between about 2800 and about 3500 cP.

In one embodiment, the thickness of the first layer 2a on one side of the conductive substrate 1 is about 80 μm. The thickness of the second layer 2b on one side of the conductive substrate 1 is about 50 μm. The total thicknesses of the first layers 2a and the second layers 2b on both sides are 160 μm and 100 μm, respectively. The total thickness of both layers is about 260 μm. The difference of the thicknesses between the two coating layers is about 30 μm, which is about 37.5% of the thickness of the first layer 2a.

Each layer of the electrode material is dried and pressed. As a result, the electrode sheet may have a higher density of the electrode active component, more uniform distribution of the electrode active component, and larger adhersion force between the electrode material and the conductive substrate. Thus, the capacity of the battery may be improved. Additionally, the glossiness of the surface of the electrode sheet may also be improved. Accordingly, the cycling performance of the battery may be increased.

In some embodiments, the coating, drying and pressing steps are performed three times to complete the preparation of a positive sheet. In one preferred embodiment, the total thickness of the positive material coated onto the conductive substrate is about 360 μm. The positive materials are coated on both sides of the conductive substrate. The total thicknesses of the first layers, the second layers, and the third layers are about 100 μm, 120 μm and 140 μm, respectively. Accordingly, the thickness of the first layer, the second lay and the third layer are about 50 μm, 60 μm and 70 μm, respectively. Preferably, the thickness of the first layer and the second layer is between 20 to 300 μm. The coating amount of the electrode material in a former coating step is less than than in a later coating step, so that the slurry is easier to be pressed compact, and the distribution is more uniform. It may be easy to obtain an electrode sheet with a higher density of electrode active component and high glossiness.

In some embodiments, preferably, each of coating, drying and pressing steps is performed twice or three times. Preferably, each step is performed twice.

The electrode material slurry may have any suitable viscosity. For example, the viscosity of the positive electrode material slurry for a nickel-cadmium battery is about preferably 4000-7000 cP. The viscosity of the positive electrode material slurry for a nickel-metal hydride battery is about 1500-3500 cP. The viscosity of the negative electrode material slurry for a lithium secondary battery is about 3000-5000 cP. In other embodiment, the positive electrode material slurry for a lithium secondary battery has a viscosity of about 2000-4000 cP. More particularly, the viscosity is about 2800-3500 cP. During the preparation of a lithium ion secondary battery, when the positive electrode material slurry has a viscosity of about 2000-4000 cP, the density of the positive active material on the electrode sheet may be uniform, and the glossiness of the electrode sheet may be high. Therefore, the cycling performance of the battery maybe be improved. If the positive electrode material slurry has a viscosity of about 2800-3500 cP, the density of the positive active material on the electrode sheet after pressing may be more uniform, and the glossiness of the electrode sheet may be better. Therefore the cycling performance of the battery may be better.

These viscosities mentioned herein are preferably measured under 25° C. at a speed of 30 n/min using a Brookfild viscometer.

According to the embodiments of the present disclosure, when the thickness of the electrode material is the same, if more coating material is used, the density of the electrode active material will be higher. Therefore the battery capacity is enhanced. The method of the present disclosure is suitable for preparing many types of battery electrode sheets for different batteries, such as nickel hydrogen batteries, nickel cadmium batteries and lithium ion batteries.

According to one embodiment of the present disclosure, a battery comprises a battery shell, an electrolyte, and an electrode assembly. The electrolyte and the electrode assembly are disposed in the battery shell. The electrode assembly comprises a positive sheet, a separator and a negative sheet. At least one of the positive and negative electrode sheets is prepared according to the present disclosure. The positive or negative electrode sheet may be the electrode sheet shown in FIG. 1. The positive or negative battery electrode sheet comprises a conductive substrate 1, and at least two electrode material layers 2a and 2b on the conductive substrate. The battery can be any battery, such as a rechargeable (secondary) battery. For example, the electrode sheet of the present disclosure can be used in a lithium ion secondary battery, a nickel hydrogen secondary battery, and a nickel cadmium secondary battery.

The electrode assembly of the secondary battery is known to those skilled in the art. Generally, the battery electrode assembly comprises a positive sheet, a separator and a negative sheet coiled or overlapped. The separator is disposed between the positive sheet and the negative sheet. The coiling or overlapping manner is known in the art and detailed descriptions are omitted.

The positive sheet of the secondary battery is known to those skilled in the art. Generally, the positive electrode sheet comprises a conductive substrate and a positive electrode material coated onto the conductive substrate.

The conductive substrate for the secondary battery is known in the art. For example, the positive conductive substrate for lithium secondary batteries may be an aluminum foil. The negative conductive substrate for lithium secondary batteries may be a copper foil. The positive conductive substrate for nickel hydrogen batteries may be a steel strip with holes, a nickel foam, and so on. The negative conductive substrate for nickel hydrogen batteries may be any suitable metal.

The positive material for secondary batteries is known to those skilled in the art. Typically, the positive material comprises a positive active component and an adhesive agent. For example, for the lithium ion secondary battery, the positive active component may be selected from the group consisting of LiCoO₂, LiNiO₂, LiMn₂O₄, LiFePO₄, lithium nickel manganese oxides, and combinations thereof. Preferably, the positive active component includes LiFePO₄. For the nickel hydrogen battery, the positive active component may be any suitable positive active component, such as nickel hydroxide.

The positive electrode may include any suitable adhesive agent known in the art. For the lithium ion secondary battery, the adhesive agent for the positive electrode may be selected from the group consisting of fluorine-containing resins and polyolefins. Polyolefins can be selected from the group consisting of polyvinylidene fluoride (PVDF), polytetrafluoroethylene (PTFE), and styrene-butadiene rubber (SBR). Generally, the weight percentage of the adhesive agent may be about 0.01-8% of the positive active material. Preferably, the percentage is about 1-5%.

The negative electrode sheet for secondary batteries may be any suitable negative electrode sheet. Typically, the negative electrode sheet comprises a negative conductive substrate and a negative electrode material coated onto the negative conductive substrate. The negative electrode material can be any suitable material. The negative electrode material generally comprises a negative active component and an adhesive agent. Optionally, the negative electrode material comprises a conductive agent.

The negative active component of a lithium ion secondary battery, may be any suitable negative active component in the art, such as carbon materials. The carbon material may be selected from the group consisting of non-graphite carbon, graphite, carbon formed from polyacetylene through high temperature oxidation, pyrolytic carbon, coke, sintered high molecular weight polymer materials, active carbon, and combinations thereof. The sintered high molecular weight polymer materials may be formed by sintering and carbonizing phenolic resins, epoxy resins etc.

The conductive agent can be any suitable conductive material. The weight percentage can be any suitable percentage known to those skilled in the art. For example, based on the total weight of the negative electrode material, the weight of the conductive agent may be about 0.1-12%. The conductive agent for the negative electrode material of lithium ion secondary batteries may be selected from the group consisting of a conductive carbon black, a nickel powder, a copper powder, and combinations thereof.

The negative active material for nickel hydrogen batteries may be any suitable negative active material that is known in the art, such as an AB₅ type hydrogen storage alloy. The conductive agent for the negative electrode in nickel hydrogen secondary batteries may be any kind of conductive agent used in nickel hydrogen secondary batteries. For example, the conductive agent may be selected from the group consisting of graphite, a conductive carbon black, a nickel powder, a cobalt power and combinations thereof. The weight percentage of the conductive agent in nickel hydrogen secondary batteries may be a conventional percentage known in the field. For example, based on the weight of the negative active material, the weight percentage of the conductive agent may be about 0.01-5%. More preferably, the percentage is about 0.02-3%.

The adhesive agent for the negative electrode in lithium ion secondary batteries may be any conventional adhesive agent used in the negative electrode of lithium ion secondary batteries. For example, the adhesive agent may be selected from the group consisting of polyvinyl alcohol, polytetrafluoroethylene, carboxymethyl cellulose (CMC), styrene-butadiene rubber (SBR), and combinations thereof. Generally, the weight percentage of the adhesive agent for the negative electrode of the lithium ion secondary batteries may be about 0.5-8% of the negative active material. More preferably, the percentage is about 2-5%. The adhesive agent for the negative electrode of nickel hydrogen batteries may be one or more selected from any kinds of hydrophobic or hydrophilic adhesive agents. For example, the adhesive agent may be selected from the group consisting of carboxylmethyl cellulose (CMC), hydroxylpropyl methyl cellulose (HPMC), methyl cellulose (MC), polyacrylic acid sodium (PAAS), polytetrafluorinethylene (PTFE), and combinations thereof.

The solvent for forming the positive electrode material slurry, and negative electrode material slurry in lithium ion secondary batteries may be any solvent used in art. For example, the solvent may be selected from the group consisting of N-methyl pyrrolidone (NMP), N,N-dimethylformamide (DMF), N,N-diethylformamide (DEF), dimethyl sulfoxide (DMSO), tetrahydrofuran (THF), water, alcohols, and combinations thereof. The amount of the solvent is suitable for forming a positive electrode material slurry from a positive active material and an adhesive agent. The amount of the solvent is sufficient to provide a slurry with suitable viscosity. The viscosity of the positive electrode material slurry can be any suitable value known in the art. For example, the viscosity of the positive electrode material slurry may be about 2000-4000 cP. More preferably, the viscosity of the positive electrode material slurry may be about 2800-3500 cP. The viscosity of the negative electrode material slurry may be the viscosity of the conventional negative electrode material in the art, such as about 3000-5000 cP.

The solvent for forming the positive electrode material slurry, and negative electrode material slurry in nickel hydrogen secondary batteries may be any solvent used in the art. The solvent for forming the positive electrode material slurry, and negative electrode material slurry in nickel cadmium secondary batteries may be any solvent used in the art. The electrolyte for nickel cadmium secondary batteries, nickel hydrogen secondary batteries is also known in the art. The detailed descriptions are omitted.

The electrolyte for lithium ion secondary batteries may be any conventional electrolyte used in the lithium ion secondary batteries. For example, an electrolyte solution may include about 0.5-2.0 mol/L electrolyte salt and a mixture solvent. The mixture solvent includes at least one of ethylene carbonate and propylene carbonate, and a low viscosity organic solvent with a viscosity no greater than 1 mPa·s. The mass ratio of ethylene carbonate and propylene carbonate to the low viscosity organic solvent is about 0.2-1.2. The low viscosity organic solvent may be selected from the group consisting of dimethyl carbonate (DMC), diethyl carbonate (DEC), ethyl methyl carbonate (EMC), methyl propyl carbonate (MPC), dimethyl sulfite (DMS), diethyl sulfite (DES), and combinations thereof. The electrolyte salt may be any conventional electrolyte salt used in the art, such as LiPF₆, LiClO₄, LiBF₄, LiAsF₆, LiSiF₆, LiB(C₆H₅)₄, LiCl, LiBr, and LiAlCl₄. Preferably, the electrolyte salt comprises LiPF₆.

According to some embodiments of the present disclosure, in the secondary battery, the separator is disposed between the positive electrode sheet and the negative electrode sheet. The separator may have both electrical insulating and liquid-maintaining properties. For example, in lithium ion secondary batteries, the separator can be selected from the group consisting of polyolefin porous membranes, modified polypropylene felts, polyethylene felts, glass fiber felts, composite films formed by binding or welding a super thin glass fiber nylon felt and a hydrophilic polyolefin porous membrane, and combinations thereof. The separator used in nickel hydrogen secondary batteries and nickel cadmium secondary batteries may be selected from various kinds of membranes used in alkali secondary batteries. For example, the separator can be polyolefin fiber and nonwoven fabrics. Hydrophilic fibers or sulfonated components can be introduced to the surface of the fabrics.

A method for preparing a secondary battery in some embodiments comprises the steps of: disposing a separator between a positive electrode sheet and a negative electrode sheet to form an electrode assembly, placing the electrode assembly into a battery shell, injecting an electrolyte into the shell, and sealing the battery shell.

The embodiments of the present disclosure will be further described with reference to the below examples.

### Example 1

### 1. Preparation of the Positive Electrode Sheet of the Lithium Ion Secondary Battery

9200 g of LiFePO₄, 400 g of PVDF, 400 g of carbon black are added into 700 g of NMP to provide a positive electrode material slurry with a viscosity of about 3000 cP.

The positive electrode material slurry is coated onto the two sides of an aluminum foil with a thickness of about 16 μm. A coating machine is used. Then, the coated foil is dried under a temperature of 120° C. for 0.5 hour. The dried foil is pressed by a pressing machine to provide a positive sheet with a first electrode material layer. The total thickness of the first layers on both sides is about 100 μm. The thickness of the first layer on each surface is about 50 μm.

The positive electrode material slurry is coated onto the first layer. The same slurry is used. Then, the positive electrode sheet is dried under 120° C. for 0.5 hour. The coated positive electrode sheet is pressed and cut into positive sheets with a size of about 600 mm×53.5 mm×0.2 mm. The pressing force applied to the positive electrode sheet in the second coating step is the same as that in the first coating step. The total thickness of the second positive material layers on both surfaces after pressing is about 150 μm. Each of the second layers is about 75 μm. Each positive electrode sheet contains the positive active material of about 18.51 g.

### 2. Preparation of a Negative Electrode Sheet of the Lithium Ion Secondary Battery

100 g of graphite, 1.9 g of carbon black, 3.5 g of SBR, and 1.0 g of CMC are added into 120 g of deionized water. The mixture is stirred in a vacuum mixing machine to form a steady and uniform negative electrode material slurry. The negative electrode material slurry is coated by a coating machine onto a copper foil with a thickness of about 8 μm. The coated conductive substrate is dried under 100° C. for 15 minutes. Then, the dried conductive substrate is pressed and cut into individual negative electrode sheets with a size of about 610 mm×55.5 mm×0.18 mm. Each negative electrode sheet contains 7.72 g of the negative active material.

### 3. Preparation of Battery

The above positive sheet, a separator and the above negative electrode sheet are overlapped and coiled to form a cylindrical core. The separator includes a PE film, a PP film, and a PE film, having a total thickness of 18 μm. Then the core is placed into a cylindrical steel shell with a diameter of 18 mm and a height of 65 mm. An electrolyte is injected into the shell. The shell is sealed to form a cylindrical lithium ion battery. The electrolyte comprises LiPF₆ with a concentration of 1 mol/L in a mixed solvent of EC, DEC and DMC with a mass ratio of 1:1:1.

### Example 2

In the example 2, the total thicknesses of the first electrode material layers and the second layers are about 150 μm and 100 μm, respectively. Accordingly, the thickness of the first electrode material layer and the second layer are about 75 μm and 50 μm, respectively. Each positive electrode sheet contains about 18.5 g of the positive active material. The other operations in the example 2 are identical with that in the example 1, and detailed descriptions thereof are omitted here.

Control 1

Comparing to the example 1, in the control 1, after the first positive electrode material layer is coated and dried, pressing is not performed. The positive electrode material slurry is coated onto the positive electrode material layer. After the second coating step, the pressing is performed to form a positive electrode sheet for a lithium ion secondary battery. The total thicknesses of the positive active material layers are about 250 μm. Each positive electrode sheet contains 16.1 g of the positive active material LiFePO₄.

Control 2

In the control 2, the positive electrode sheet for a lithium ion secondary battery is prepared by using the conventional preparation method in which the coating operation is performed only once. After pressing, the total thickness of the positive electrode material (not including the thickness of the positive conductive substrate) on the positive electrode sheet is about 250 μm, which is the same as that in example 1. The density is 167 kg/m³. Each positive electrode sheet contains 13.42 g of the positive active material LiFePO₄.

The chemical materials and testing equipments used in the present disclosure are shown as table 1 and table 2.

The peel strength, battery capacity and cycling performance at room temperature are tested according to the methods below. The results are shown as table 3.

The sheet is cut into individual electrode sheets with a size of about 120 mm×40 mm. Then, the peel strength testing equipment in table 2 is used to test the peeling force between the coating layer and the conductive substrate.

The batteries are charged at about a current of about 1 C to a voltage of about 4.2 V at room temperature. Then, the batteries are charged at a constant voltage, with a cut-off current of about 0.05 C. The batteries are discharged at about a constant current of about 1 C to a voltage of about 2.75 V. The designed capacity C is about 2500 mAh.

According to the above initial discharge capacity testing method, 100 cycles are performed. Then, the discharge capacity of the battery is tested. The ratio of the discharge capacity after 100 cycles to the initial discharge capacity is the battery capacity maintaining rate (%).

TABLE 1
Chemical Material in the Examples.

| Chemical Materials | Purity Level | Source |
|---|---|---|
| LiFePO₄ | Battery level | Tianjin STL Energy |
| | | Technology Co., Ltd. |
| Adhesive agents | Battery level | Tianjin STL Energy |
| | | Technology Co., Ltd. |
| Carbon black | Battery level | Tianjin STL Energy |
| | | Technology Co., Ltd. |
| NMP | Industry level | Tianjin STL Energy |
| | | Technology Co., Ltd. |
| Graphite | Battery level | Tianjin STL Energy |
| | | Technology Co., Ltd. |

TABLE 2
Testing Equipments.

| Names | Manufacturer and Models |
|---|---|
| Constant-temperature and | Qingsheng KTSB-410TBS |
| Humidity Oven | |
| Brookfild Viscometer | Brookfild Company |
| Peel Strength Testing Machine | Taiwan Shunyin Co., Ltd. |

TABLE 3
The Performance of the Electrode Sheets and the
Batteries.

| Examples | Example 1 | Example 1 | Control 1 | Control 2 |
|---|---|---|---|---|
| Number of | 2 | 2 | 2 | 1 |
| Layers | | | | |
| Thickness | First Layer: 100 | First Layer: 150 | First Layer: 100 | 250 |
| (μm) | Second Layer: | Second Layer: | Second Layer: | |
| | 150 | 100 | 150 | |
| Whether | Yes | Yes | Not Pressing | Yes |
| Pressing | | | After the First Coating | |
| Density of the | 230.64 | 230.52 | 200.64 | 167.24 |
| positive active | | | | |
| material(kg/m³) | | | | |
| Viscosity of the | 3000 | 2500 | 3000 | 2800 |
| Positive | | | | |
| Electrode | | | | |
| Material Slurry | | | | |
| (25° C., cP) | | | | |
| Peel Strength | 5.12 | 5.10 | 3.82 | 2.40 |
| (N/m) | | | | |
| Initial | 2470 | 2468 | 2180 | 1810 |
| Discharge | | | | |
| Capacity | | | | |
| (mAh) | | | | |
| Capacity | 100% | 99.4% | 85% | 91% |
| Maintaining | | | | |
| Rate | | | | |
| (%) | | | | |

When the thickness of the conductive substrate is the same, the positive electrode sheet for lithium ion secondary battery prepared according to embodiments of the present disclosure has a higher density, and improved peel strength between the positive material and the conductive substrate. The peel strength reaches about 5.1 N/m.

When the thickness of the conductive substrate is the same, the lithium ion secondary battery prepared according to embodiments of the present disclosure has improved initial discharge capacities and capacity maintaining rates after 100 cycles at room temperature. The capacity maintaining rate after 100 cycles reaches about 95%.

At room temperature and when the viscosity of the positive electrode material slurry is about 3000 cP, the capacity maintaining rate after 100 cycles is better than the capacity maintaining rate when the viscosity of the positive electrode material slurry is about 2500 cP.

Although the examples in the present disclosure have been described with reference to positive electrode sheets in lithium ion secondary batteries, those skilled in the art may understand that the method may be applied to negative electrode sheets in lithium ion secondary batteries, and nickel hydrogen battery sheets, and nickel cadmium battery sheets. Therefore, any method of preparing battery electrode sheets comprising a conductive substrate and at least two electrode material layers would fall in the scope of the present disclosure.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A battery electrode sheet, comprising:
a conductive substrate having two sides; and
a first and second layer of an electrode material on at least one side of the conductive substrate, the first and second layers being deposited in separate steps.

2. The sheet of claim 1, wherein both sides of the conductive substrate are coated with a first and second layer of the electrode material.

3. The sheet of claim 1, wherein the thickness of the second layer is greater than that of the first layer.

4. The sheet of claim 1, wherein the difference of the thicknesses between the first and second layer is no greater than about 50% of the thickness of the layer that has a greater thickness.

5. The sheet of claim 1, wherein the first layer has a thickness of between about 20 and about 300 μm.

6. The sheet of claim 1, wherein the second layer has a thickness of between about 20 and about 300 μm.

7. The sheet of claim 1, wherein the density of the first layer is greater than that of the second layer.

8. The sheet of claim 1, further comprising a third layer of the electrode material on the second layer.

9. The sheet of claim 8, wherein the thickness of the third layer is greater than that of the second layer, and the thickness of the second layer is greater than that of the first layer.

10. A method for preparing a battery electrode sheet, comprising:
providing a first slurry of an electrode material;
coating the first slurry onto a conductive substrate to form a first layer of the electrode material;
drying the first layer;
pressing the first layer;
providing a second slurry of an electrode material;
coating the second slurry onto the first layer to form a second layer of the electrode material;
drying the second layer; and
pressing the second layer to form a battery electrode sheet.

11. The method of claim 10, wherein the first slurry and the second slurry have the same components.

12. The method of claim 10, wherein the steps of the pressing on the first and second layers are performed with the same amount of force.

13. The method of claim 10, wherein the pressing is performed on the first layer twice; and the pressing is performed on the second layer only once.

14. The method of claim 10, wherein the first and second slurrys have a viscosity of between about 2000 and about 4000 cP.

15. The method of claim 14, wherein the viscosity is between about 2800 and about 3500 cP.

16. The method of claim 10, further comprising:
providing a third slurry of an electrode material;
coating the third slurry onto the second layer to form a third layer of the electrode material;
drying the third layer; and
pressing the third layer to form a battery electrode sheet.

17. A battery, comprising:
a battery shell;
an electrolyte disposed in the battery shell; and
an electrode assembly disposed in the battery shell, the electrode assembly comprising:
a positive sheet;
a negative sheet; and
a separator disposed between the positive sheet and the negative sheet;
wherein at least one of the positive sheet and the negative sheet comprises a conductive substrate with two sides, and a first and second layer of an electrode material coated on at least one side of the conductive substrate; and wherein the first and second layers are deposited in separate steps.

18. The battery of claim 17, wherein the density of the first layer is greater than that of the second layer.

19. The battery of claim 17, wherein the thickness of the second layer is greater than that of the first layer.

20. The battery of claim 17, wherein the battery is a rechargeable battery.
